(19) United States
(12) Patent Application Publication
(10) Pub. No.: US 2010/0242365 A1
(43) Pub. Date: Sep. 30, 2010

(54) SLIDING WINDOWS, DOORS AND THE LIKE

(75) Inventors: Robert Charles Langner, Victoria (AU); Frank Kaj Glydendal Langner, Victoria (AU)

Correspondence Address: OCCHIUTI ROHLICEK & TSAO, LLP, 10 FAWCETT STREET, CAMBRIDGE, MA, 02138, US

(73) Assignee: Aneeta Window Systems (Vic) Pty Ltd, Mitcham (AU)

(21) Appl. No.: 12/675,572

(22) PCT Filed: Aug. 29, 2008
(86) PCT No.: PCT/AU2008/001265

§ 371 Date: May 21, 2010

(30) Foreign Application Priority Data
Aug. 29, 2007 (AU) 2007904680

(51) Int. Cl. E05D 15/10; E05D 15/06; E06B 3/46; E06B 7/14

(52) U.S. Cl. 49/130; 49/404; 49/425; 49/408

(57) ABSTRACT

A sliding window, door or the like (10), including at least two panes (23, 24) which extend in a generally vertical plane and at least one of which is movable generally horizontally, a sill (11) including a channel (17) that extends generally horizontally and within which bottom edge portions of each of the at least two panes (23, 24) are received, a dividing member (20) within the channel (17) which extends between the at least two panes (23, 24). The dividing member (20) extends either in contact with or in close facing relationship with the bottom edge portions of the at least two panes (23, 24).

### FIELD OF THE INVENTION

The present invention relates to sliding windows and doors and similar structures. In particular, although not exclusively, the invention relates to windows that include at least one sliding pane.

### BACKGROUND TO THE INVENTION

The discussion immediately below relates to prior art in the field of the invention, but it is not to be taken as an admission of common general knowledge.

Sliding windows that presently exist are subject to various drawbacks. For example, sliding windows generally permit some ingress of water and/or air. The resistance to such ingress is known as a weather rating with the higher the rating, the greater the resistance to ingress.

Horizontal sliding windows often include a low profile channel shaped lower sill for receipt of the bottom edge of a window pane. Disadvantageously however, rain that falls against the outside of the window can collect within the channel and leak into the building in which the window is installed. Accordingly, drainage slots can be provided through the channel to drain any collected water. However, such slots can reduce the weather rating by allowing ingress of wind through the slots. Thus, horizontal sliding windows generally have a lower weather rating than other types of windows and therefore they have heretofore been unpopular, especially in high wind locations such as coastal and high-rise locations where the effects of wind are greater than locations that are inland or low-rise.

Lock mechanisms are frequently provided that are rigidly mounted on the inside of the sill and include a mechanism operable to horizontally move a projection so as to engage the pane and thereby lock the window against sliding. In order to prevent water leaking through the sill via the lock mechanism, it is necessary to mount the lock to the sill in a relatively high position. This requires greater height and therefore creates increased visual bulk of the window sill and pane frame members that is otherwise unnecessary.

Additionally, the panes of a sliding window can sit directly within the channel of the lower sill or they can be supported by rollers or wheels within the sill. Because of the clearance necessary to allow the pane or panes to slide, a problem with such windows is the tendency for the window pane and/or the rollers or wheels to rattle within the sill. The clearance can also contribute to allow ingress of air and water through the sill and into the building in which the sill is mounted.

Further, in some forms of horizontal sliding windows, the sliding pane is received within a head channel at its top and within a sill channel at its bottom. In order to assemble the window, some existing arrangements install the head and sill first and employ a spacing between the inner ends of the channels of the head and sill which is significantly greater than the height of the pane. This allows the pane to be installed from outside or inside by first inserting the top of the pane substantially fully into the head at an angle and then swinging the pane through an arc to insert the bottom of the pane into the sill, and finally, lowering the pane to sit in the sill. This unfortunately means that, without a suitable lock, the pane can be removed in the reverse order from the outside of the window, allowing unauthorised entry through the window. Thus, the security of the window can be low. Moreover, the spacing in the head can further contribute to the ingress of air into the building in which the head is mounted.

It is an object of the present invention to provide an arrangement which overcomes or at least alleviates one or more of the foregoing disadvantages of the prior art.

The invention and background art are described with reference to windows. However the skilled addressee will understand that the invention is also applicable to other similar structures such as sliding doors. The term “window” is therefore to be understood in a broader sense to encompass windows and doors and any other like structures.

The term “pane” is used principally to embody a glass sheet, which may or may not be a framed sheet. However, the term “pane” is not restricted to glass sheet and may for example include any transparent or opaque material, such as polycarbonate (transparent) or timber (opaque). The term is also intended to encompass double glazed units of two or more sheets of glass or other suitable material.

As used herein, the term “comprise” and variations of the term, such as “comprising”, “comprises” and “comprised”, are not intended to exclude other additives, components, integers or steps.

### SUMMARY OF THE INVENTION

A sliding window, door or the like, is provided which includes:
at least two panes which extend in a generally vertical plane and at least one of which is movable generally horizontally,
a sill including a channel that extends generally horizontally and within which bottom edge portions of each of the at least two panes are received,
a dividing member within the channel which extends between the at least two panes, the dividing member extending either in contact with or in close facing relationship with the bottom edge portions of the at least two panes.

While the invention covers an arrangement in which only a single pane is movable, the invention also encompasses arrangements in which the window includes two or more movable panes. In some arrangements, the window will include a pair of panes with each pane being movable, but in other arrangements, the window could include a plurality of fixed and movable panes.

The invention can extend to panes which are sashed panes, or sashless panes. In either arrangement, the window can include pane receiving members that can be applied at the bottom edge of a pane and, if appropriate, at the top edge as well. The pane receiving members typically cooperate with the sill and/or the head, and in some arrangements, the pane receiving members which receive the bottom edge of the panes, can include rollers or wheels, or a roller or wheel assembly or the like, to facilitate sliding movement of the pane within the window.

The dividing member advantageously assists to present a barrier to the progression of wind or rain through the sill, in particular if the sill includes drainage slots or the like to drain water which might collect in the sill. The dividing member thus can resist the ingress of wind and water through the sill, such as through the drainage slots. Thus, by the provision of the dividing member, the weather rating of a window which embodies the invention can be increased, potentially significantly.

The height of the dividing member is somewhat proportional to the level of resistance that the dividing member provides to the ingress of wind or rain through the sill. A feature of the present invention is that the dividing member can have a significant upward extent to about the same height as the walls of the channel of the sill.

The channel of the sill is defined by outer and inner side walls and a base which extends between the side walls. In some arrangements, the dividing member extends from the base, upwardly and in some forms, generally parallel to the inner and outer walls.

The upward extent of the dividing member and the inner and outer walls can vary to suit the particular installation requirements, including the weather rating requirements. In some arrangements, the dividing member can have an upward extent which is greater than one or each of the inner and outer walls, while in other arrangements, one or each of the inner and outer walls can have a greater upward extent than the dividing member. In some windows according to the invention, as indicated above, the height of the inner and outer walls and the dividing member is approximately equal. This has a further advantage in that it provides a clear sight line at the sill of the window. That is, none of the inner or outer walls, or the dividing member, extend upwardly to a greater extent than the other. This provides a significant aesthetic improvement in the look of the window.

In some arrangements of the invention, the base of the sill channel can be inclined downwardly either towards the dividing member or the outer wall of the channel. This advantageously can promote urging of the pane into engagement with the dividing member or the outer wall, or the seals, such as brush seals, attached to the dividing member or the outer wall so as to reduce the likelihood of the pane rattling within the sill and also improving the weather rating of the window. In some arrangements, the pane receiving member can include a roller or wheel assembly which rolls on the base. Where the window includes a pair of movable panes, disposed on either side of the dividing member, the base of the channel can include two inclined base sections which decline in the same direction, so that one pane is urged towards the dividing member and the other pane is urged towards the outer wall. The base, or a portion thereof on which a pane is supported, can be inclined between about 5° and 15° from the horizontal, although about 5° has been found to be very effective to provide the urging force required.

Suitable seals can be disposed between the sill and the or each movable pane, and for example, brush seals can be employed to take up any gaps between the panes and the sill and to thereby present a further barrier against the progression of wind or rain through the sill. Other seals can be employed such as foam, bulb or silicon seals.

In some arrangements, the lower portion of the sill can include first and second passages below the channel, which extend substantially for the length of the sill and which are positioned adjacent to each other, transverse to the length of the sill. In these arrangements, the channel can include drainage apertures or slots in order to drain any water that enters the channel into at least one of the first and second passages. Further drainage apertures can be provided between the first and second passages, so that water that drains into the first passage can drain into the second passage, while further drainage apertures can be provided between the second passage and the external or outer wall of the sill so that water can drain out of the sill from the second passage. Promotion of drainage from the first to the second passage and from the second passage to outside of the sill, can be provided by inclined base surfaces of the passages. Thus, the passages can each have an inclined base that declines towards the outside of the sill. The base of the first passage can be co-extensive with the base of the second passage.

In some arrangements, it is desirable to capture water within the sill in order to provide a barrier against passage of wind through the sill. In order to achieve this, drainage apertures which are provided between the second passage and the outside of the sill can be positioned upwardly of the base of the second passage, so that water fills the sill to the level of the drainage passage before draining out of the sill. Effectively, this arrangement forms a water trap to trap water within the sill.

The outer side of the sill may be provided with drainage apertures in the form of seepage apertures which permit only slow drainage of the water trap such that during rain, the lower portion can fill, to create a water trap as described above, but will later drain to release the trapped water.

Any of the apertures described above can be covered by suitable valves, such as flap valves, which are rotatable in a drainage direction, to allow drainage of water through the apertures, and which bear against the apertures to close them when subject to a wind loading or water pressure in the opposite direction. Thus, the flap valves are operable to present a barrier to the passage of wind and water through the sill from outside the sill to inside, but are equally operable to allow drainage of water from the sill in the opposite direction.

The sill can be formed of a plurality of parts that are formed separately and assembled together. Employing parts of this kind can facilitate ease of assembly of the window or door. In one form, the sill is comprised of two interconnectable parts that can be snap-fitted together. The first part can be secured to the frame of the window prior to the second part being connected to it. This can increase the ease of assembly or installation. Alternatively, the sill can be of unitary construction. The first and second passages can be of constant cross-section along their length.

The base of the channel can have a first portion, such as a track, for supporting a respective sliding window and can further define a second portion, such as a gutter below the track into which ordinary debris such as dirt, grime and dust, can collect for removal. Drainage apertures can be provided in the base of the channel such as in the second portion and advantageously, debris can be removed through the apertures during water drainage. These drainage apertures may be in the form of slots. The base of each channel can be transversely inclined to promote drainage to the drainage apertures.

The lower portion of the sill can be in the form of a longitudinal receptacle into which the drainage apertures communicate. The lower portion can include a longitudinal partition to define two passages of the kind discussed above. The partition can extend fully to the base of the lower portion and include apertures for flow of water past the partition, or it can be spaced from the base to create a small gap between the end of the partition and the base. The partition may include one or more flap valves to control the flow of liquid through the apertures or the small gap.

Advantageously, a sill can be configured so that air movement through the sill via any drainage apertures as a result of wind corresponding to a wind pressure of up to 10 mm water, is substantially prevented. In fact, air movement through the sill via the drainage apertures can be substantially prevented up to higher wind pressure of about 30 mm to 40 mm water without the sill becoming overly large or cumbersome.

The present invention extends to a sill of the kind described above, that can be incorporated into a window frame, door frame or like construction.

The sliding window, door or the like can include a head which is spaced from the sill and which comprises a channel that extends generally horizontally and in which upper edge portions of each of the at least two panes are received. The head channel can include a dividing member which extends between the upper edge portions of the at least two panes. The dividing member can extend either in contact with or in close facing relationship with the upper edge portions of the at least two panes.

Like the sill, the head channel has opposing side walls that extend generally parallel for at least a significant portion of their downward extent, and each of the side walls and the dividing member can extend downwards about the same amount to provide a clear sight line at the head.

The head channel can be formed of at least two parts which are snap-fitted together. In one arrangement, the head channel is formed of three parts, a first of which is secured to the frame of the window, door or the like, the second part of which is snap-fitted to the first part, and the third part of which is snap-fitted to the first or the second part. This facilitates the installation, removal and maintenance of the panes from the window. Moreover, this arrangement permits a closer fit between the head and the top of the pane, so that a pane cannot be lifted out of the window in the manner of the prior art. This is regardless of whether the window is locked shut or not. Thus, the security of the window can be increased significantly. Further, the disassembly of the head can be arranged to be permitted only from the inside of the window and not the outside.

In some forms of the invention, the window can include a lock. In the above arrangement, in which the top of the pane fits closely within the head, advantageously, the lock is not required to prevent removal of the pane from the window. Rather the lock is only required to prevent sliding movement of the pane. The lock can therefore be fitted above the sill rather than to the sill, so that the prior art problem of wind and water ingress through the lock mechanism is reduced or eliminated, while the size of the sill can be reduced.

These are significant advantages.

Still further, a lock can be installed to lock the panes in an open condition of the window, such as with an opening gap of 50 mm or 100 mm, again without concern that the panes can be lifted out of the window in the manner of the prior art.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

The invention consists in the foregoing and also envisages constructions of which the following gives examples.

### BRIEF DESCRIPTION OF THE DRAWINGS

In order that the invention may be more fully understood, some embodiments will now be described with reference to the figures in which:

FIG. 1 is a side sectional view of a window arrangement according to one embodiment of the invention.

FIG. 2 is a side view of a wheeled bogie for use in a window according to the present invention.

FIG. 3 is a perspective view of the wheeled bogie of FIG. 2.

FIG. 4 is an end perspective view of a sill arrangement for use in a window according to the present invention.

FIG. 5 is a sectional view of a sill arrangement according to one embodiment of the present invention.

FIG. 6 is an exploded view of a three part head arrangement for use in a window according to the present invention.

FIG. 7 illustrates the method of assembly of the panes in relation to the head of FIG. 6.

FIG. 8 is a side sectional view of a further window arrangement according to the invention, which embodies three panes.

FIGS. 9 to 12 show some of many different combinations of movable and stationary panes which can be incorporated into windows according to the present invention.

FIG. 13 is a side sectional view showing a window arrangement according to the invention which employs double glazed panes.

FIG. 14 is a plan view of a two pane window according to the present invention.

FIG. 15 is a plan view of a three pane window according to the present invention.

### DETAILED DESCRIPTION

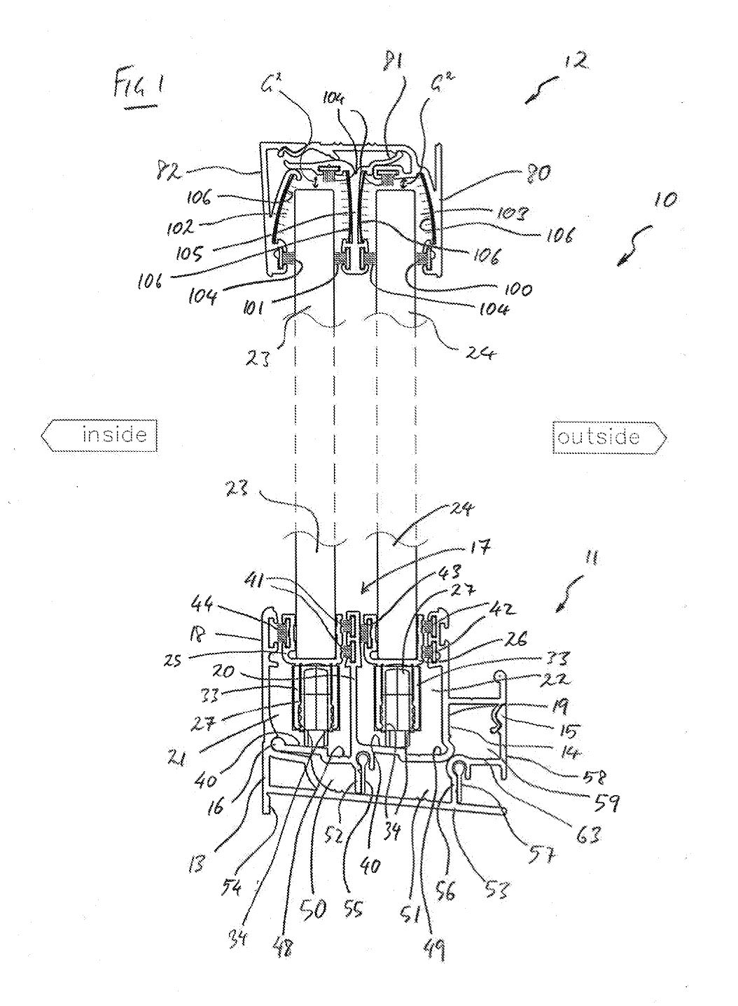

FIG. 1 is a cross-sectional view of a horizontal sliding window in accordance with one embodiment of the present invention showing the sill and head, and the upper and lower portions of the window panes. The window 10 includes a sill 11 and a head 12. Referring first to the sill 11, this comprises a two-part snap together construction, comprising a sill base 13 and a sill insert 14. The base 13 and the insert 14 are connected together by a nesting arrangement at nesting points 15 and 16. The method of connection is by engaging the sill base 13 and the sill insert 14 at the nesting point 16 and then rolling or rotating the sill insert 14 relative to the sill base 13 to snap connect the nesting point 15.

The sill 11 defines a channel 17, between an inner wall 18 and an outer wall 19. Within the channel 17 is a dividing member 20, and the arrangement is that each of the inner wall 18, the outer wall 19 and the dividing wall 20 extend generally vertically and generally parallel to each other. The dividing member 20 thus divides the channel 17 into separate sub-channels 21 and 22 each of which receives a bottom edge and supporting structure of respective window panes 23 and 24.

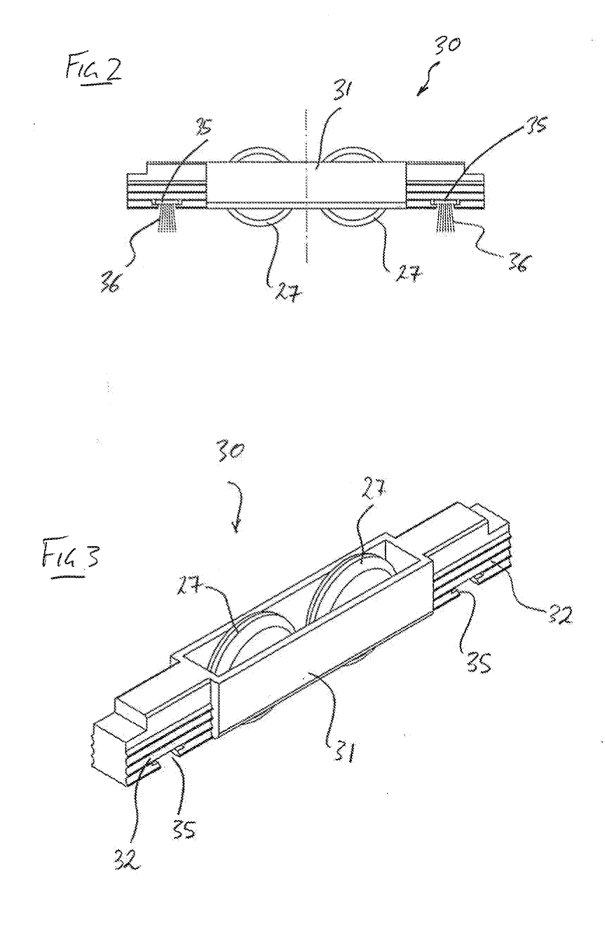

The window panes 23 and 24 each include a pane receiving assembly 25 and 26, which receives the bottom edge of the panes 23 and 24 and each of which includes a roller or wheel 27. The wheels 27 form part of a wheeled bogie which is illustrated in more detail in FIGS. 2 and 3. Referring to those figures, it can be seen that the bogie 30 includes a pair of wheels 27 mounted within a frame 31, which includes corrugated or serrated ends 32. Those ends are received within a U-shaped channel 33 of each of the pane receiving assemblies 25 and 26, which channels include inwardly facing protrusions 34 on each of the free ends of the channel 33 which protrusions 34 engage within the corrugated ends 32. This arrangement facilitates height adjustment of the pane receiving assemblies 25 and 26 relative to the bogie 30, by selection of the particular corrugation of the ends 32 into which the protrusions 34 are engaged.

FIGS. 2 and 3 also show recesses 35 which are formed in the bogies 30 and which are provided to each receive a brush seal 36, which advantageously are operable to sweep ahead of the rollers 27 as the bogie moves forward and back within the channel 17 of the sill 11, in order to clear debris from the path of the rollers 27. This advantageously reduces wear on the wheels 27 and maximizes the smoothness of rolling of the bogies 30 within the channel 17.

The wheels 27 of the bogie 30 run along the floor portion 40 of each of the sub-channels 21 and 22. The floor portion 40 of each channel 21 and 22 is inclined, within the floor portion 40 of the channel 21 declining from the inner wall 18 towards the dividing member 20, and the floor portion 40 of the channel 22 being declined at substantially the same angle. The inclination of the floor portion 40 of each of the channels 21 and 22 is such as to urge each of the panes 23 and 24 in the direction downwardly of the floors 40. Thus, the pane 23 is urged into contact with the brush seals 41 extending from the dividing member 20, while the pane 24 is urged into contact with the brush seals 42 which extend from the outer wall 19. By this arrangement, rattling movement of the panes 23 and 24 within the channel 17 is either eliminated or substantially reduced, while a secure weather seal is formed between the respective brush seals 41 and 42 and the panes 23 and 24. This improves the weather rating of the window 10.

It can be seen that the brush seals 41 and 42 are captured within recesses formed in the outer wall 19 and the dividing member 20, while further brush seals 43 and 44 are captured within recesses formed in the pane receiving assemblies 25 and 26. The respective brush seals 41 to 44 can take any known form.

The sub-channels 21 and 22 include further floor portions 48 and 49 which are stepped downward from the adjacent floor portions 40. The floor portions 48 and 49 are generally horizontal, although their orientation is not particularly important.

The floor portions 48 forms a gutter and can include drainage apertures in order to drain rain water that enters the channel 21 into the chamber or passage 50 which is positioned below the channel 21. While not shown in FIG. 1, the apertures can comprise discrete openings in the floor portion 48 which are spaced along the length of those portions periodically.

Drainage openings can also be positioned through the downwardly extending leg 52 which extends from the sill insert 14 in order to permit drainage of water from the passage 50 to the passage 51. To promote this drainage, the common floor 53 of the passages 50 and 51 slopes downwardly from the elevating leg. In order for that drainage to occur, drainage apertures can be provided through the leg 52, while a flap valve 55 can be employed to impede the flow of water in the opposite direction. In addition, the flap valve 55 is operable to impede the flow of air through apertures formed in the leg 52 to prevent ingress of air through the sill 11.

A further leg 56 extends upwardly from the floor 53 and defines the lower end of the passage 51. In order to drain water from the passage 51, drainage apertures can be provided within the leg 56, and for the same reason as provided in relation to the leg 52, a flap valve 57 can be provided to overlie any drainage apertures provided in the leg 56. Thus, drainage apertures provided in each of the legs 52 and 56 promote drainage of water that flows from the channel 21 into the passages 50 and 51.

For water that enters the channel 22, drainage apertures can be formed in the outer wall 19 of the sill insert 14, to drain into the passage 59. Drainage apertures can be positioned through the base 63 of the passage 59 so that water flows from the channel 22 into the passage 59 and thereafter through the base 63 for drainage from the sill 11.

It is to be noted that the passages of drainage described above are completely independent. This allows the chamber 21 to drain more easily as drainage from that chamber is not interfered with by wind or water that enters the chamber 22. It is to be noted that the chamber 22 receives far more water than the chamber 21, because half of the chamber 22 is always fully open to wind and rain, whereas this is not the case for chamber 21.

In addition, the independent drainage arrangement discussed above provides further protection for the channel 21, which, given it is the inside channel is the more critical channel to protect, by the provision of the flap seal 55 which can produce a pressure drop on the outside of the seal.

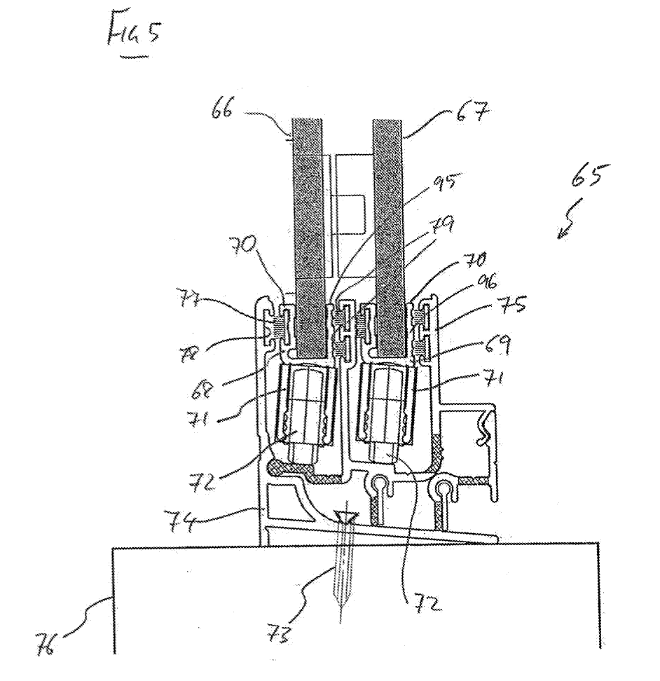

The drainage arrangement discussed above is more apparent from FIG. 5 which shows in shaded sections of the sill base 13 and sill insert 14, the various drainage apertures discussed above.

The various flap valves typically would be made from a rubber or plastic, and advantageously, the valves are concealed from sight and from sunlight, so that they do not deteriorate from exposure to UV radiation.

The arrangement of the window 10 need not include the drainage apertures precisely as described above, but rather, the arrangement can be such as to promote filling of the passages 50 and 51 to create a water trap. Thus, drainage apertures can be excluded from the leg 56, so that as water enters the passage 51, it slowly fills that passage and prevents further drainage of water from the passage 50. By this arrangement, water trapped within the passages 50 and 51 provides resistance to the passage of air through the sill 11.

In the arrangement described above, apertures can be provided in the gutter 49, the outer wall 19 and the base 63 to permit drainage of water from the sill 11 when the water level within the sill 11 reaches those drainage apertures.

The above arrangement can alternatively include weep holes, which are small openings provided in the leg 56 of the sill 11 and which allow water to weep out of the sill 11 at a very slow rate.

The use of drainage apertures in the floor portion 48 provides a further advantage associated with the use of the bogies 30 and the brush seals 36 (see FIGS. 2 and 3). As described above, the brush seals 36 brush debris from the floors 40 of the channels 21 and 22, that debris would normally fall from the inclined floor portion 40, to the floor portions 48 and 49 and eventually through the drainage apertures and into the respective passages 50 and 59. Thus, the present arrangement provides a simple yet effective mechanism to remove debris which accumulates within the channels 21 and 22.

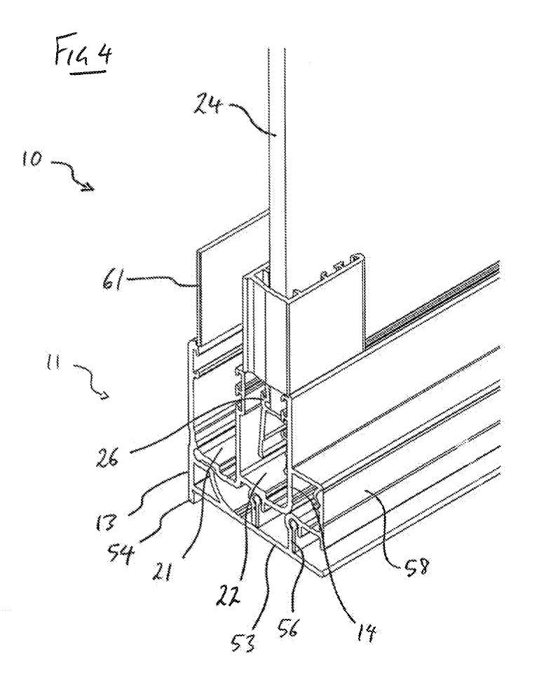

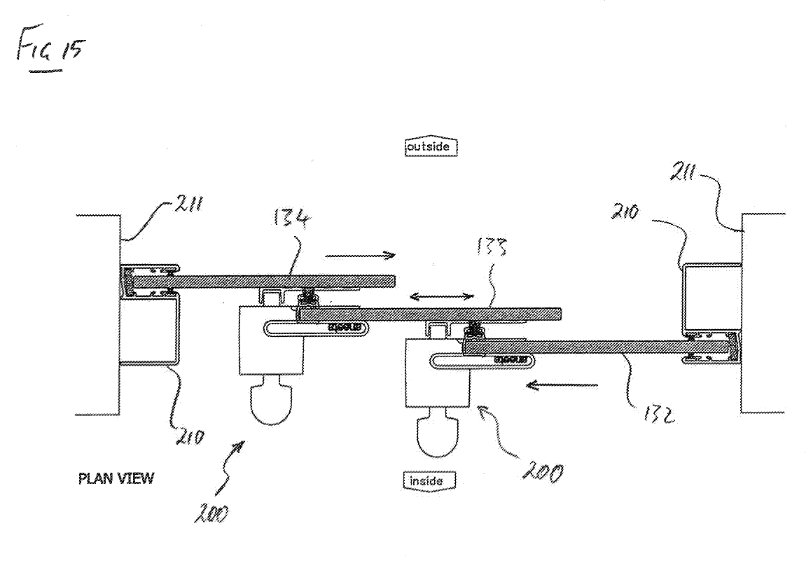

FIG. 4 is a perspective view of the sill portion of the window 10 which illustrates a portion of the lengthwise extent of that arrangement. Only a small number of reference numerals have been shown in FIG. 4 for clarity purposes. FIG. 4 illustrates an edge jamb 61, which extends for the height of the window, so that in FIG. 4, only a short portion of the actual jamb 61 is illustrated. FIG. 14 shows the jamb arrangement in plan view, in which a pair of jambs 61 are attached to the vertically extending frame members 62 of a window or door frame. The panes 23 and 24 can slide in the direction of the arrows shown in FIG. 14 in accordance with the earlier description of FIG. 1.

Before discussing the construction of the head 12 of the window 10, reference will now be made to FIG. 5, which shows an alternative arrangement to the sill 11 of FIG. 1.

In FIG. 5, a sill 65 is illustrated which in many respects is the same as the sill 11 of FIG. 1. What is apparent from a comparison between the sills 11 and 65, is that the panes 23 and 24 are of a greater thickness compared to the panes 66 and 67 of FIG. 5 and in the arrangements illustrated, the panes 23 and 24 are 10 mm thick, while the panes 66 and 67 are 6 mm thick. It is within the scope of the present invention to accommodate single panes of any reasonable thickness, such as up to 25 mm thick and down to 5 mm. However, the invention also extends to double glazed windows which can be of 22 mm thickness or even 32 mm thick or even greater.

Because of the similarities between the sill 65 and the sill 11, only the differences will be described further in relation to the sill 65.

It is readily apparent from FIG. 5, that the pane receiving assemblies 68 and 69 include an upper channel 70 for receiving the bottom edge of the panes 66 and 67, and a lower channel 71 for receiving a roller bogie 72. In this arrangement, the upper channel 70 is generally co-planar with the vertically extending panes 66 and 67, while the lower channel 71 extends at a slight angle to the upper channel 70. This is to assist installation of the panes, particularly panes of smaller thickness, such as 6 mm thickness. The angled lower channel 71 assists entry of the pane receiving assemblies 68 and 69 into the sub-chambers of the sill. The angled arrangement is not necessarily required or appropriate for larger thickness panes, such as the 10 mm panes 23, 24 of FIG. 1.

FIG. 5 also illustrates a screw 73 which can be applied to the sill base 74 prior to connecting the sill insert 75 to the base 74. FIG. 5 illustrates the screw 73 penetrating into the frame 76 of a window or door or the like. A similar arrangement can be adopted in relation to the sill base 13 of FIG. 1.

It can be seen in FIG. 5, that the brush seal 77 is captured in the upper end of the upper channel 70 of the pane receiving member 68 and projects away from the pane 66. In the FIG. 5 arrangement (and in the FIG. 1 arrangement also), the brush seal 77 projects into a recess 78. The extension into the recess 78 is shown as only slight in FIG. 5, but in practice, the brush seal 77 can extend much further into the recess 78 than shown in FIG. 5.

The advantage of the brush seal 77 extending into the recess 78, is that it further convolutes the path of wind or rain through the sill 65, therefore providing greater resistance to ingress of wind or rain and improving the weather rating of the sill 65.

An arrangement having a similar effect, but being constructed in a different manner relates to the brush seals 79, which extend into sliding contact with the upstanding member 95 of the upper channel 70. The surface of the member 95 which faces the brush seals 79 is formed with a slight recess and central rib in order to create a similar interference to the passage of wind and rain as is described in relation to the recess 78. The arrangement of the upstanding member 95 is repeated in relation to the upstanding member 96 of the other channel 70.

As indicated above, the arrangements discussed above are repeated also in FIG. 1.

In all other respects, operation of the sill 65 is the same as the sill 11 of FIG. 1 and therefore further comment in relation to the sill 65 is not required.

Returning to FIG. 1, and with reference to the head 12, that head includes a three part snap-together construction. The three parts of the head 12 are illustrated in an exploded condition in FIG. 6 and reference will be made to both FIGS. 1, 6 and 7 in order to describe the head 12.

The head 12 includes a base portion 80, a centre portion 81 and a cover portion 82. The head 12 is assembled by firstly positioning the base portion 80 in the window frame and driving a nail or screw 83 through the horizontal portion 84 of the base portion 80. It will be appreciated that a plurality of screws 83 are driven through the base portion 80 along its length. Once the base portion 80 is secured as discussed above, the centre portion 81 can be snapped into position as shown in FIG. 1, by the arm 85 being pushed into the gap G¹ and the protrusion 86 being received within the recess 87. Thereafter, the cover portion 82 can be snapped into place by the protrusion 88 of the arm 89 being pushed into nesting engagement in the recess 90 of the base portion 80. In that nested condition, the distal end of the arm 91 of the cover portion 82 bears against the portion 92 of the centre portion 81.

When correctly extruded, the assembled head 12 of FIG. 1 is both extremely stable and strong.

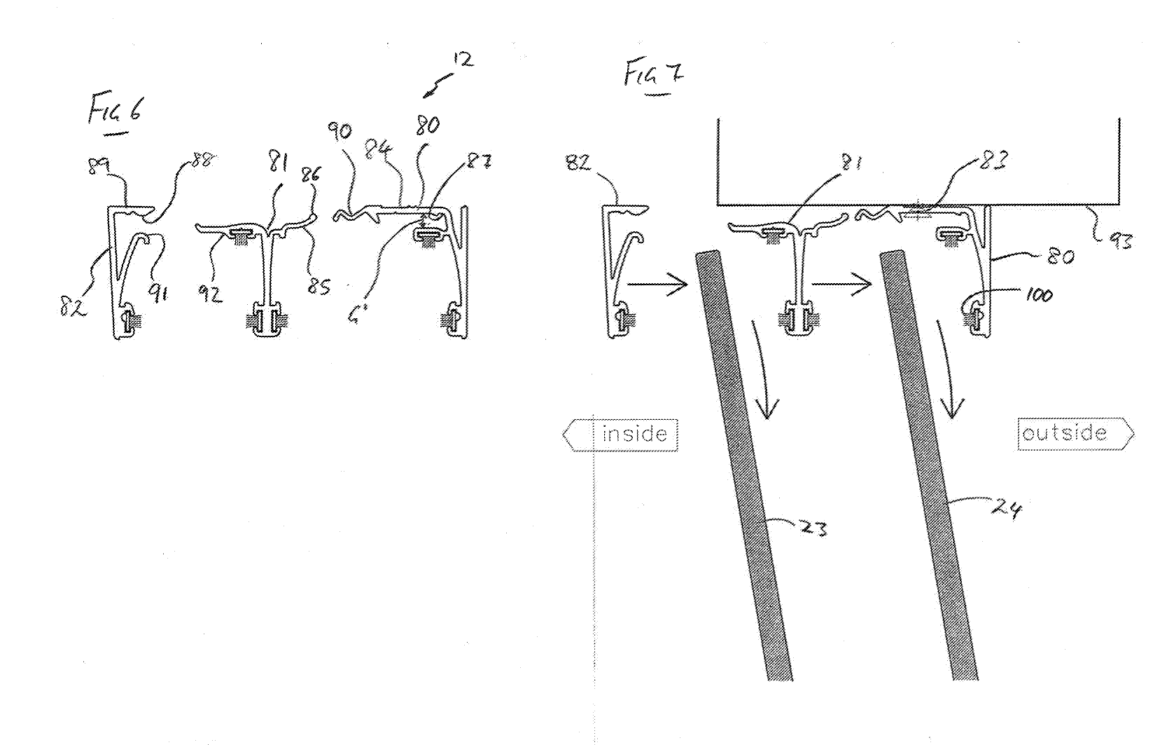

The advantage of providing the head 12 in a three part configuration is evident once the assembly of the window 10 is taken into account. FIG. 7 illustrates the assembly procedure and with reference to that figure and FIG. 1, the procedure is as follows.

Firstly, the sill 11 is fixed in place to the window frame. This is fitted as explained before by firstly fitting the sill base 13 and driving a nail or screw through the base to secure it to the window frame and thereafter connecting the sill insert 14 to the base 13. Next, the base portion 80 of the head 12 is fixed to an upper portion 93 of the window frame by screws 83, as described in relation to FIG. 6. Thereafter, the bottom of the pane 24 is inserted into the sub-channel 22 and as shown in FIG. 7, the pane 23 is rotated clockwise into the position it assumes in FIG. 1, in which it bears against the brush seal 100.

With the pane 24 in position as shown in FIG. 1, the centre portion 81 can be snapped into connection with the base portion 80. With the centre portion 81 in place, the bottom edge of the pane 23 can be inserted into the sub-channel 21 of the sill 11 and again, as shown in FIG. 7, the pane 23 can be rotated clockwise to bring it into a vertical position in bearing engagement with the brush seal 101. With the pane 23 in that position, the cover portion 82 of the head 12 can be snapped into position, again as discussed in relation to FIG. 6. The head 12 is thus assembled, with the panes 23 and 24 captured within adjacent channels 102 and 103.

It is to be appreciated that the brush seals 100 and 101 already described, and the additional brush seals 104 shown in FIG. 1, are all installed prior to the snapping together of the various portions 80, 81 and 82.

Further seals can extend from seal bases 106 into continuous contact with the panes 23 and 24 to further resist ingress of wind and water.

A significant benefit provided by the arrangement of the head 12, is that the gap G² between the upper edge of the panes 23 and 24 and the facing components of the head 12, is very small compared to prior art arrangements which employ a single piece head and a different method of installation. For example, early in this description, a prior art method of installation was described as first inserting the top of a pane into the head at an angle and then swinging the pane through an arc to insert the bottom of the pane into the sill. In that arrangement, the space between the upper edge of a pane and the facing parts of the head is large, to enable the pane to clear the upstanding walls of the sill prior to being lowered down into the sill. Thus, the drawback was outlined, that this type of window can be unsecure in the absence of a suitable lock, because the pane can be removed from the window by reversing the steps of installation, i.e. by lifting the pane upwards into the head so that the bottom edge of the pane clears the upstanding walls of the sill, and swinging the sill through an arc to shift it away from the sill.

It will be clearly evident from FIG. 1, that the gap G² is not sufficient to allow either of the panes 23 or 24 to be lifted upwards sufficient for the bottom of the panes to be removed from the channels 21 and 22 of the sill 11. Thus, the security of a window according to the invention can be significantly increased compared to the type of prior art arrangement previously described. In addition, the portions of the head 12 which are snapped together can be snapped apart for improved access for servicing the window 10 from the inside of a building within which the window 10 is installed. FIG. 1 illustrates the inside and outside facing portions of the window 10 and it will be evident that by deinstalling the cover portion 82 of the head 12, that the pane 23 can be removed. This allows for maintenance to be carried out on the sill 11, for example to clear debris from within the channel 21. The centre portion 81 can also be removed if it is necessary to remove the pane 24. It is to be noted that only the base portion 80 is fixed to the window frame by means of nails or screws, so that each of the centre and cover portions 81 and 82 can be assembled and disassembled relatively easily and quickly.

Still further, with the inclusion of the further seals extending from the bases 106, and with the top of the panes closely received within the head 12, the free space within the head is significantly less than the prior art, so that the weather rating of the head can be higher than the prior art.

FIG. 1 also illustrates that each of the sill 11 and the head 12 employ significant dividing members or centre fins, in the form of the dividing member 20 in sill 11 and the centre fin 105. Applicant has established that the use of such centre fins provides significant side or lateral support for the panes 23 and 24 particularly in high wind by supporting the windows against rattling and by enhancing the barrier to ingress of rain and wind from outside of the window to the inside. In addition, the dividing member 20 and dividing member 105 enhance the security of the window 10 against pane removal from outside of the window, by limiting the amount of movement of the panes 23 and 24 within the head 12.

A further significant benefit provided by the arrangement of FIG. 1, is that the upper ends of each of the inner and outer walls 18 and 19 of the channel 17, the upper ends of the pane receiving assemblies 25 and 26 and the upper end of the dividing member 20, all have approximately the same upward extent or height. This differs from prior art arrangements, in which the components of the sill can create an uneven line of sight, by different components projecting to different heights.

It will be appreciated that the height of the pane receiving assemblies 25 and 26 and the dividing member 20 can all be reduced in height compared to that shown in FIG. 1 and still retain the clear line of sight that FIG. 1 provides. Alternatively, the pane receiving assemblies 25 and 26 and the dividing member 20 can extend slightly upwardly beyond the upward extent of the walls 18 and 19 of the channel 17, and not disturb the clean line of sight adversely. The dividing member 105 can have a reduced downward extent, or can extend further than the portions 80 and 82, without adversely affecting the clean line of sight of the head 12.

The advantage discussed above in relation to the line of sight is a significant advantage provided by the present invention as the window 10 has a superior appearance in relation to its neatness and symmetry compared to many of the prior arrangements.

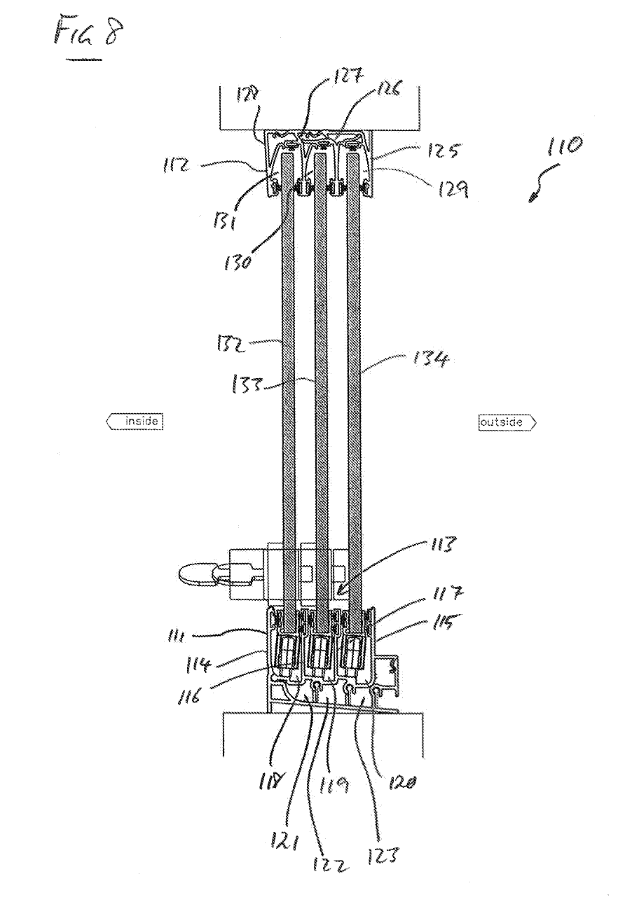

FIG. 8 illustrates an arrangement which is similar to FIG. 1, but which includes three panes compared to the FIGS. 1 and 5 arrangements which employ two panes. In FIG. 8, the window 110 includes a sill 111 and a head 112. Given the many similarities between the sill 111 and head 112 and the earlier sill 11 and head 12 of FIG. 1, only the differences will be described in relation to FIG. 8.

In relation to the sill 111 a channel 113 is formed between an inner wall 114 and an outer wall 115. A pair of dividing members 116 and 117 extend upwardly within the channel 113 generally parallel to the inner and outer walls 114 and 115 and to substantially upward extent. The sill 111 therefore includes three sub-channels 118, 119 and 120.

The bottom floor of each of the sub-channels 118, 119 and 120 are formed in substantially the same manner as the floors 40 of FIG. 1, while below each of the floors of the sub-channels 118, 119 and 120, is a passage 121, 122 and 123. It will be readily apparent to a person skilled in the art, that drainage apertures can extend between the sub-channels 118, 119 and 120 to drain water into the sub-passages 121, 122 and 123, and from those passages, to the outside of the sill 111.

In relation to the head 112, the snap-fit arrangement of the head 12 of FIG. 1 is employed in a modified form but it will be apparent from the discussion that follows, that that form has a variety of advantages.

The head 112 comprises a base portion 125, a first centre portion 126, a second centre portion 127 and a cover portion 128. The difference between the head 112 of FIG. 8 and the head 12 of FIG. 1, is the addition of the second centre portion 127. That facilitates the creation of a new channel 130 which sits between channels 129 and 131, which are equivalent to the channels 102 and 103 of FIG. 1. The manner of installation of the head 112, is that the base portion 125 is fitted to the frame of a window with the use of a nail or screw, and thereafter the first centre portion 126 is snap-fitted to the base portion 125, followed by the second centre portion 127 being snap-fitted to the first centre portion 126 and finally, the cover portion 128 is snap-fitted to the second centre portion 127. The assembly of the head 112 takes place with insertion of the respective panes 132, 133 and 134 in the manner already illustrated in FIG. 7.

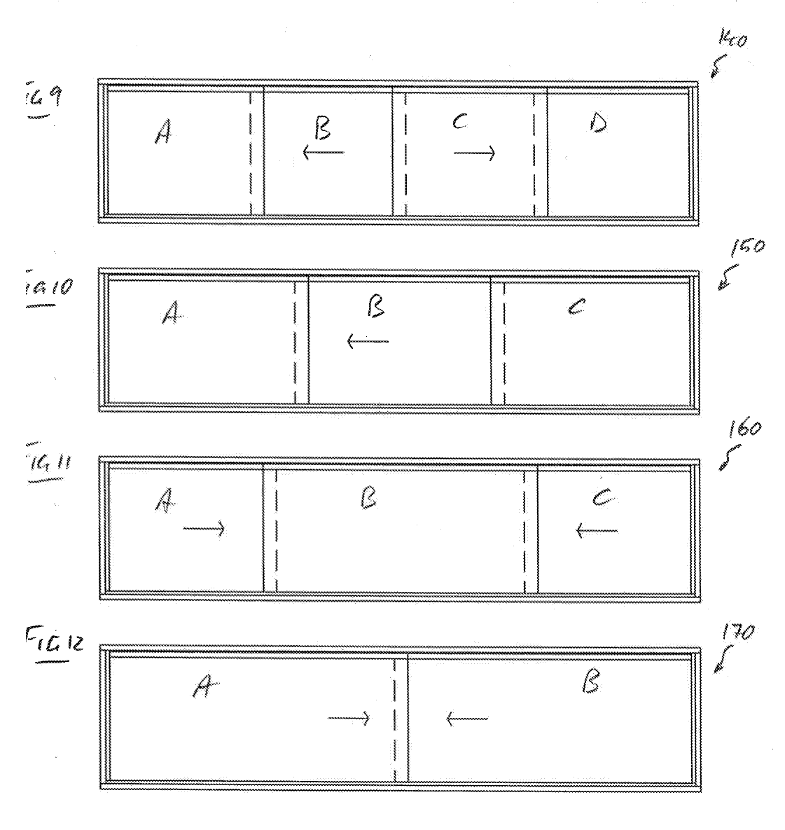

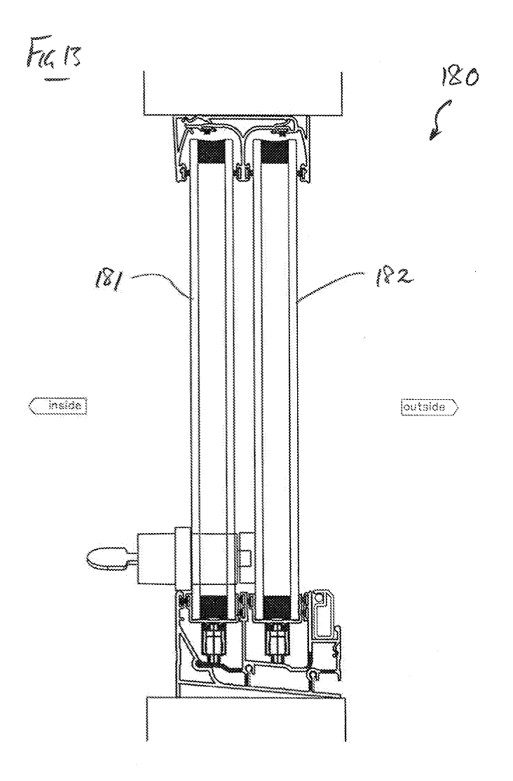

A comparison between the embodiments of FIGS. 1 and 8 illustrates that the invention applies to windows having two panes (FIG. 1), and windows having three panes (FIG. 8). However, the invention can be applied to windows having even a greater number of panes than three and FIGS. 9 to 12 illustrate further different pane arrangements among the large number which are applicable to the present invention. Referring to FIG. 9, this shows a four pane window 140, in which panes A and D are stationary and panes B and C are movable. In FIG. 10, the window 150 includes three panes A, B and C, in which only the pane B is movable. In FIG. 11, the window 160 is also a three paned window, in which panes A and C are movable and pane B is stationary. Finally, in the window 170 of FIG. 12, a two pane window is illustrated, in which both panes A and B are movable. This is an arrangement of the kind illustrated in FIG. 1.

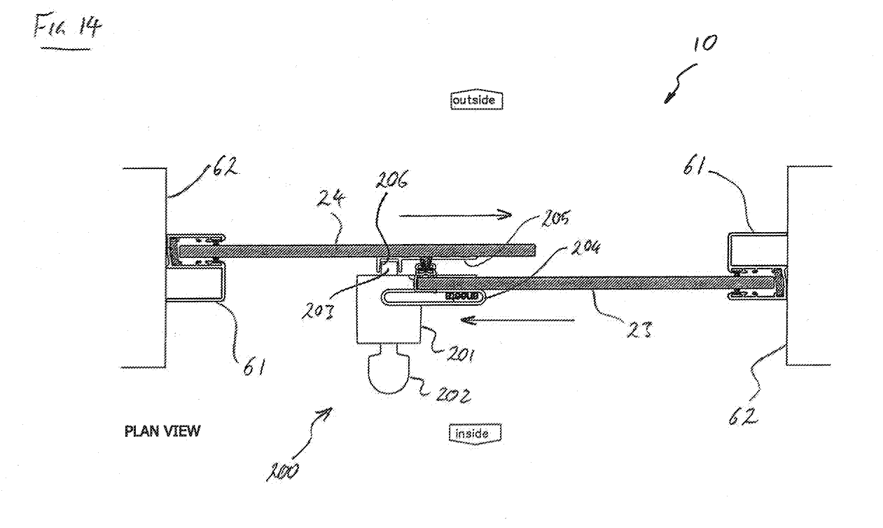

FIG. 13 shows a window arrangement 180 which is similar in most respects to the window 10 of FIG. 1. What FIG. 13 illustrates, is the employment of double glazed panes 181 and 182 to replace the single sheet panes 23 and 24 of the window 10. Each of the panes 181 and 182 includes two spaced apart but generally parallel panes with an air gap between them. Such double glazed panes are useful for maximizing the weather and sound insulation properties of a window.

In other respects, the window of FIG. 13 is the same as the window 10 of FIG. 1 and therefore no further discussion of window 180 will be made.

Each of FIGS. 8, 14 and 15 show lock arrangements applied to the windows described. With reference first to FIG. 14, the lock arrangement 200 includes a barrel 201, a removable key 202 extending from one end of the barrel 201, and a plunger 203 extending from the opposite end of the barrel.

The barrel 201 is fixed to one edge of the pane 203 via a channel 204 into which the edge of the pane 203 is inserted. A suitable adhesive is applied to fix the channel 204 to the edge of the pane 203.

Adhesively attached to the facing surface of the pane 204, is a plunger receptacle 205, which defines a recess 206 into which the plunger 203 can extend. In that extended condition, the pane 203 is locked relative to the pane 204.

The lock mechanism of the arrangement 200 can be of any suitable kind and for example, the plunger 203 can assume a retracted position in an unlocked condition of the panes 23 and 24, and a push button actuator can be employed at the end of the barrel 201 opposite the plunger 203 to extend the plunger 203 into receipt by the recess 206. Once the plunger has been extended and received within the recess 206, the key 201 can be rotated and removed to lock the plunger in the extended position.

FIGS. 8 and 15 illustrate the same lock arrangement 200 employed in FIG. 14, but illustrate the arrangement as applied to the three window pane arrangement of FIG. 8. FIG. 15 is a plan view of FIG. 8, showing side jambs 210 which extend vertically and which are fixed to vertically extending frame members 211 of a window or door frame. The lock arrangements 200 of FIGS. 8 and 15 are identical in all other respects to the same arrangement shown in FIG. 14.

The lock arrangements of the figures can have a single recess 206 as illustrated, or two or more recesses to lock the panes in one or more open positions.

The foregoing describes only some embodiments of the present invention and modification may be made thereto without departing from the present invention.

1. A sliding window or door comprising:
at least two panes which extend in a generally vertical plane and at least one of which is movable generally horizontally,
a sill comprising a channel that extends generally horizontally and within which bottom edge portions of each of the at least two panes are received,
a dividing member within the sill channel which extends between the at least two panes, the dividing member extending either in contact with or in close facing relationship with the bottom edge portions of the at least two panes.
a head spaced from the sill and comprising a channel that extends generally horizontally and within upper edge portions of each of the at least two panes are received.
wherein the head channel including a dividing member which extends between the upper edge portions of the at least two panes, the dividing member extending either in contact with or in close facing relationship with the upper edge portions of the at least two panes, and the head channel being formed of at least two parts which are snap-fitted together.

2-9. (canceled)

10. A sliding window or door according to claim 1, the sill channel including a first base portion on which at least one of the at least two panes is moveable, the first base portion being inclined downwardly.

11. A sliding window or door according to claim 10, the inclination of the first base portion being about 5° to horizontal.

12. A sliding window or door according to claim 10, the movable pane being supported by a wheel or roller assembly on the first base.

13. A sliding window or door according to claim 10, the sill channel including a second base portion on which another of the at least two panes is moveable, the first and second base portions being inclined downwardly in the same direction.

14. A sliding window or door according to claim 13, the inclination of the first and second base portions each being about 5° to horizontal.

15. A sliding window or door according to claim 13, each movable pane being supported by a wheel or roller assembly on the respective first and second base portions.

16. A sliding window or door according to claim 1, the sill including first and second passages below the sill channel which extend substantially for the length of the sill and which are positioned adjacent each other transverse to the length of the sill, the sill channel including drainage apertures to drain into at least one of the first and second passages.

17. A sliding window or door according to claim 16, drainage apertures being formed between the first and second passages, to facilitate drainage from one passage to the other.

18. A sliding window or door according to claim 17, the sill having an outer side and an inner side, the first passage being disposed adjacent to the outer side and the second passage being disposed adjacent to the outer side on the inner side of the first passage, and drainage apertures being provided between the outer side and the first passage.

19. A sliding window or door according to claim 18, the drainage apertures provided between the outer side and the first passage being positioned above the drainage apertures formed between the first and second passages.

20. A sliding window or door according to claim 18, the first and second passages each including a base that declines from the inner side to the outer side to facilitate drainage from the inner side to the outer side.

21. A sliding window or door according to claim 20, the base of the first and second passages being substantially coplanar

22. A sliding window or door according to claim 1, the sill channel having opposing side walls that extend generally parallel for at least a significant portion of their upward extent, each of the side walls and the dividing member extending to about the same height.

23. (canceled)

24. A sliding window or door according to claim 1, the sill being formed of two interconnectable parts that are snap-fitted together.

25. (canceled)

26. A sill for a sliding window or door according to claim 1.

27-28. (canceled)

29. A sliding window or door according to claim 1, the head channel having opposing side walls that extend generally parallel for at least a significant portion of their downward extent, each of the side walls and the dividing member extending downwards about the same amount.

30. (canceled)

31. A sliding window or door according to claim 1, the head channel being formed of three parts, a first of which is secured to the frame of the window or door, the second part of which is snap-fitted to the first part, and the third part of which is snap-fitted to the second part.

32. A method of assembling a sliding window or door according to claim 1, the method including:
i—securing the sill to the frame of the window or door,
ii—securing a first part of the head channel to the frame of the window or door,
iii—inserting the bottom edge portion of a first angled pane into the sill and rotating the pane into a vertical position in engagement with the first part of the head channel,
iv—snap-fitting the second part of the head channel to the first part of the head channel,
v—inserting the bottom edge portion of second angled pane into the sill and rotating the pane into a vertical position in engagement with the second part of the head channel, and
vi—snap-fitting the third part of the head channel to the second part of the head channel.
